(19) United States
(12) Patent Application Publication
(10) Pub. No.: US 2003/0216941 A1
(43) Pub. Date: Nov. 20, 2003

(54) Method for determining a customized cosmetic product

(76) Inventor: Thaddeus Dominick Berry, Wauwatosa, WI (US)

Correspondence Address: BRADLEY M GANZ, PC, P O BOX 10105, PORTLAND, OR, 97296

(21) Appl. No.: 10/434,291

(22) Filed: May 7, 2003

Related U.S. Application Data
(60) Provisional application No. 60/381,712, filed on May 20, 2002.

(51) Int. Cl. G06F 17/60

(52) U.S. Cl. 705/2

(57) ABSTRACT

A method for determining, customizing and providing client-specific cosmetic products.

This invention claims the benefit of co-pending U.S. Provisional Application No. 60/381,712 entitled PROCESS TO GATHER, ANALYZE, DEVELOP AND DELIVER CUSTOMIZED SALON HAIR CARE PRODUCTS FOR AT HOME APPLICATION filed on May 20, 2002, the entire disclosure of which is hereby incorporated by reference and set forth in its entirety for all purposes.

### BACKGROUND OF THE INVENTION

This invention relates to a method of customizing client-specific cosmetic products. This invention contemplates to a method for determining an appropriate hair coloring product based on unique characteristics of an individual client.

Attempts have been made over the years to improve the cost effectiveness of customized cosmetic products. Many of the prior art approaches require a client to travel to a specialized salon to obtain customized cosmetic products. In addition to salon treatments being relatively expensive, they may also require scheduling appointments, involve lengthy treatment time and undesirable travel.

Other solutions provide a generic, over-the-counter, formulations available in convenient locations, such as the supermarket. However, these solutions do not customize products to the individual and/or are poorly composed and may not match the needs of an individual client.

Purchasing conventional products in public outlets may also lead to embarrassment, or otherwise be wasteful when clients find the products are unsuitable for their needs. Accordingly, conventional thinking is that only salons can provide and apply customized cosmetic products and services, and that they should demand a high retail price.

### SUMMARY OF THE INVENTION

The present invention overcomes the foregoing problems by providing a unique and advantageous personal data gathering process that can be used in a number of economical formats that will allow for customized mixing or customized selection, or both, of a cosmetic product or products. The product or products may then be tailored to client-specific requirements. One contemplated application of the present invention is a process for the determination, selection and mixing of customized salon hair care and coloring products, and services. These products then may be used at the client's location of choice and convenience.

The present invention contemplates a direct approach, which does not require clients to travel to salons or other locations to obtain customized hair products. Rather, clients can order products and services from their home or office, or other remote location by using the computer, phone, mail, facsimile machine, or other data communication system.

The evaluation/analysis process of the present invention is a unique and cost effective way to gather technical data necessary to customize the salon mixtures. These custom hair care products may better match a client's physical and aesthetic attributes and better meet a client's expectations for salon quality products, greater durability and consistent level of service and results.

The evaluation/analysis process enables a technician to gather, analyze and process individual client information over the phone or Internet, for example. This process saves time and typical costs often associated with actual salon visits to exchange similar information with hair care professionals.

The direct approach enables customization of product and service to meet the needs of a large number of clients from a variety of geographic locations at a lower cost than established local salons. Traditional hair salons typically charge premium fees to help offset larger operating expenses including rent, salaries and equipment for each technician.

In addition to lower costs for customized salon products, the ordering process is available 24 hours a day from the convenience of a client's computer or telephone, for example. This convenience saves wasteful travel, and shopping and appointment time. This enhanced level of convenience is a unique approach to help clients customize and order a range of hair care and cosmetic products.

In one possible embodiment, hair color swatches (actual hair samples, synthetic hair samples, printed or electronic color representations of hair samples, for example) are distributed directly to clients to help clients and technicians specifically identify a client's natural hair color, existing color and target hair colors to custom mix a formula and optimize the quality and durability of the hair and cosmetic products.

In addition to the hair color swatches, optional digital imaging and video streaming technologies may be used to model hair and facial colors, textures, and tones. All information gathered may be used to formulate the products and services that meet a client's exacting needs.

Once a client's formula is established, additional products and services can be custom developed and mailed directly to the client or picked up at home or remote location, for example.

The present invention may be differentiated from traditional over-the-counter hair care products because clients complete an evaluation/analysis of their unique hair and beauty features. A technician may then customize products and services to the specific physical attributes and needs of clients. Generic formulas of the prior art provided by over-the-counter products available in drug stores, department stores, grocery stores, convenience stores, for example, do not customize the product to unique client attributes.

The present invention contemplates a system that provides greater portability of customized cosmetic products. This method may be suitably applied to many settings beyond traditional hair salons. For example, the present process enables technicians at nontraditional-salon locations; such as nail salons, tattoo parlors, tanning salons, grocery stores, and any other location where a computer can be linked, for example, to facilitate the process of selecting a customized hair product.

The foregoing is not intended to be an exhaustive list of embodiments and features of the present invention. Persons skilled in the art are capable of appreciating other embodiments and features from the following detailed description in conjunction with the drawings.

### BRIEF DESCRIPTION OF THE DRAWINGS

FIG. 1 illustrates a flow chart of a method of the present invention.

FIG. 2 illustrates a process flow of one possible method of the present invention.

FIG. 3 illustrates a process flow of one possible method of the present invention.

FIG. 4 presents a block diagram of a possible method of the present invention.

### DETAILED DESCRIPTION OF THE INVENTION

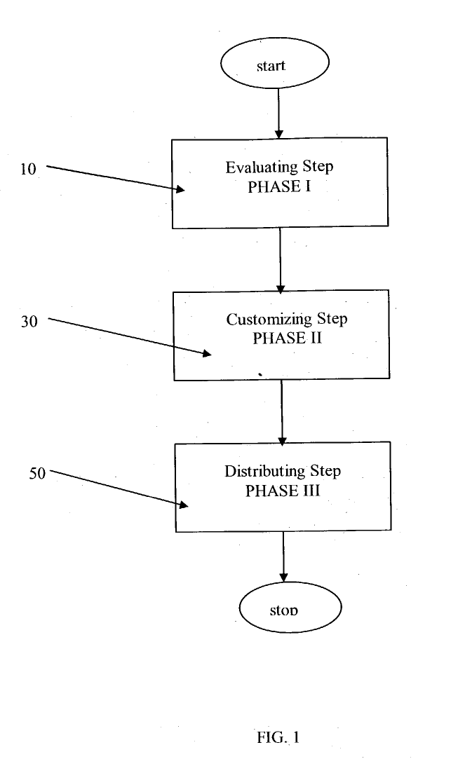

The present invention contemplates a three-phase process for the selection of an appropriate coloring for a client's hair. The general process is illustrated in FIG. 1, which shows a set of phases according to the present invention. The first phase 10 comprises the evaluation and analysis step, which is conducted directly with the client and may be conducted over the phone, or Internet, for example. This phase may involve posing one or more questions, the answers to which create a hair color profile for the client. The second phase 30 is the step of product customization and fulfillment. The third phase 50 is the step of distribution and ongoing services. In this description, each phase will be detailed to include specific resources and operational requirements.

Making reference now to FIGS. 1-4, wherein similar features share a common reference numeral, possible embodiments of the present invention are discussed.

Phase One: Evaluation and Analysis

The purpose of the evaluation and analysis phase 10 is to gather detailed information from an individual client. This information is used by technicians to custom-mix and produce hair products of exacting specifications for the best possible results.

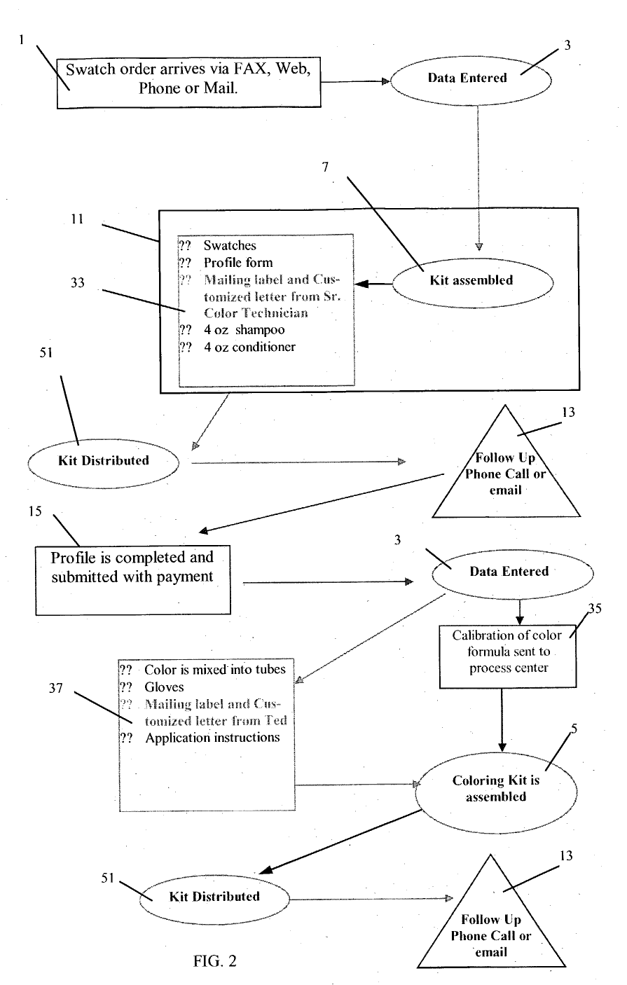

The gathering of client evaluation information may be done via the Internet, over the phone, or by completing a hard copy of the evaluation and mailing or faxing the information, as represented in FIG. 2 as block 1. And then the profile data may be entered into a database, as represented in block 3.

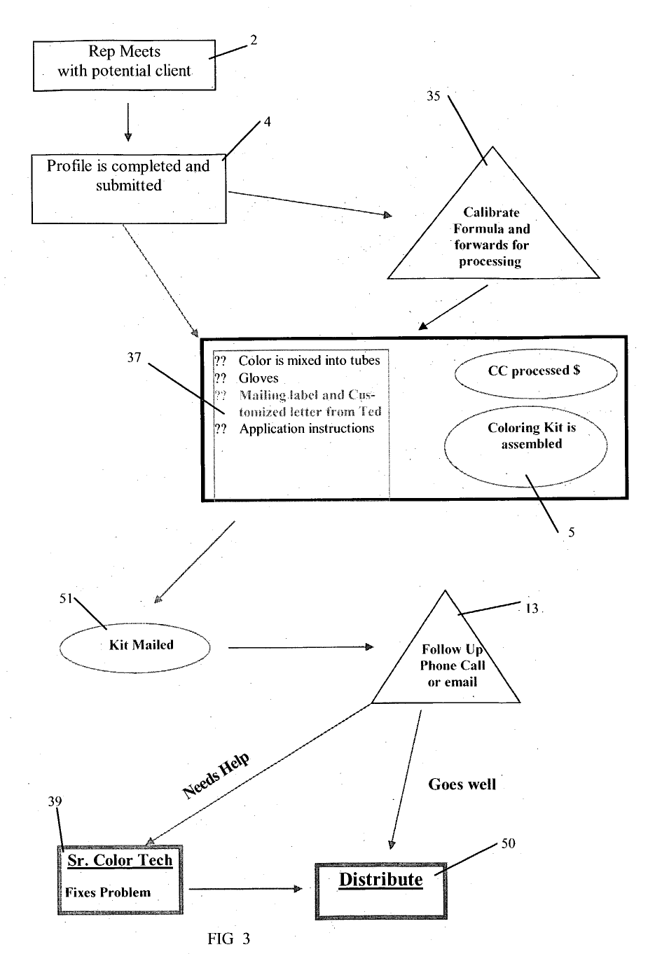

Alternatively, the gathering of client information may be conducted by a representative, as represented in the FIG. 3 as block 2. Then, a completed profile is submitted, as represented in block 4.

On-line: To complete the evaluation on-line, the client will need a computer with Internet access. On their computer, the client logs onto a specific website, for example www.haircolortogo.com. From the home page of the website, the client may access an analysis interface, such as a web page entitled “Do Your Analysis Now”. This link may be available from all the pages on the selected website.

On the analysis page, clients will be instructed to complete the evaluation -on-line. A technician may optionally assist in the completion of the evaluation stage of the process.

On the phone: To complete the evaluation over the phone, the client may dial a toll-free number, for example, and speak directly with a technician. The technician may ask all of the appropriate questions to complete the evaluation. Then the technician may process the information and develop a custom formula according to the client's exacting specifications.

Direct Mail: The client may also choose to have an evaluation mailed directly to them for completion. The questions and options on the direct mail evaluation form may be the same as what appears on-line or what would be asked over the phone. A technician may optionally assist in the completion of the evaluation stage of the process.

Use of Color Swatches

Optionally, a set of hair color swatches may be used in the analysis/evaluation process. A complete of set of hair color swatches may include from one to fifty different hair samples. Each individual hair sample may be two inches long and labeled with a tag that specifies a color code used to identify natural root color, existing hair color, and target hair color. These swatches may be mailed directly to the client with a return envelope. This unique process of mailing sample swatches with a color code identification system guarantees accurate color identification, and product customization of salon products to clients specific needs.

To assist the client with evaluating the existing hair color and the target hair color when creating a profile, a client may obtain hair color swatches or other appropriate samples. Accordingly, an order for color swatches may be processed, block 1. The data may be entered, block 3 and the kit assembled, block 7.

The kit may include various items, as represented by block 33. Included in the kit may be a profile form to be completed by the client, shampoo, conditioner, and color swatches, for example.

The kit would then be distributed to the client, block 51. The kit may be distributed by any means of delivery, such as mail, overnight delivery, or the client may collect it, for example.

Optionally, a follow up phone call, e-mail, facsimile or other communication may be made to the client, block 13. This step may be used to assess satisfaction with the kit and to facilitate completion of the client profile.

In due course, the profile would be completed by the client and returned, block 15. In some instances, the profile may be completed by the client with assistance from a sales rep, for example, block 2.

The Color Profile

First the client provides contact information, which may include: name, complete mailing address, e-mail address, phone numbers for home and work, occupation, user name and a password. The contact information may be registered into a database so client-specific formulas can be recorded for future reference, updates and orders.

In a possible embodiment, clients would be asked to provide one or more of the following personal attributes for creating a hair color profile:

1. Recording the client's eye color. Eye colors may be: Brown, Blue, Blue/Gray, Green, Hazel, Green/Gold, or Green/Brown, for example. Eye color information helps in the identification of complementary hair colors, as well as indicates probable mineral salt levels in the client's body. Two mineral salts of note are iron and copper. The presents of these minerals affect the oxidation of hair chemicals and ultimately the coloring agents.

Iron percentages can be more concentrated in people with darker skin and complexion colors, and lower levels of iron are generally found in people with lighter skin complexion and colors.

Accordingly, the brighter the color the eyes (blue and green eye shades), the fairer the skin and the less concentrated the iron levels in the hair. Conversely, the darker the eyes (Brown and Gold) the less fair the complexion and more concentrated iron levels in the hair.

2. Assessing the work history of the client's hair. A typical question to ask a client might be “Has your hair been permed, straightened or highlighted or bleached recently, and if so, when?” To aid in assessing this information, additional questions concerning how long ago work has been performed on the client's hair may be helpful. For example, time periods of: in the last two weeks; 2-4 weeks ago; 4-8 weeks ago; or more than 8 weeks ago, may be useful to know. This information provides the technician a point of reference to understand what has worked in the past, and what hasn't. Additionally, some of these product residues may still be in the client's hair, which can affect the formulation for appropriate hair products.

3. Determining the ethnicity of the client. Knowledge of the ethnicity of the client is useful. For example, it may be helpful to know whether the client is Celtic, Nordic, Asian, African, Hispanic, or Mediterranean. Ethnicity information helps the identification of complementary hair colors, as well as indicates probable mineral salt levels in the clients body. Mineral salt levels such as copper and iron are helpful to know when determining the most appropriate formula for hair coloring and hair care products.

4. Assessing the client's skin tone. Skin tones may be classified as fair, fair/medium, medium, medium/dark, or dark, for example. The skin tone aesthetic information helps in the understanding of the depth of skin, hair and mineral salt levels so that an appropriate formula can be mixed.

5. Assessing the client's skin undertones. Common undertones are pink, red, yellow, gold, olive, blue, or pale. The skin undertone aesthetic information helps in the understanding of the depth of skin, hair and mineral salt levels so that an appropriate formula can be mixed.

6. Determining the client's hair texture. Typical hair textures may include: fine/straight, medium/straight, coarse/straight, fine/wavy, medium/wavy, coarse/wavy, fine/curly, medium/curly, and coarse/curly, for example. The texture information helps the technician determine the appropriate quantity/percentage of developer to be applied to the customized formula mix.

7. Assessing the client's hair thickness: Hair thickness, or density, may be described as fine/thin, medium, or thick, for example. The density information further assists the technician determine the appropriate quantity/percentage of developer to be applied to the customized formula mix.

8. Determining the condition of the client's scalp. A scalp may be classified as normal, dry, oily, damaged, or sensitive, for example. The scalp information helps the technician understand or know of potential allergies or physiological conditions that may effect the customized formula, application instructions, and/or product results.

9. Indicating any hair coloring allergies. The scalp information helps the technician understand or know of potential allergies or physiological conditions that may effect the customized formula, application instructions, and/or product results.

10. Describing the length of hair: Hair length may be classified as: short—above the ear, medium—at or below ear, medium/long—chin or below, long—shoulder, or below, for example. Hair length helps the technician prescribe the appropriate quantities for application and the duration of the application process.

11. Determining the client's hair porosity. Typical porosity levels may include: not porous, grabs color on hairline, grabs color on ends, grabs color on hairline and ends, for example. This information is used to determine the degree of product absorption by the hair so therefore affects the chemical formulation and application timing and treatment for the best possible results and durability.

12. Determining the amount of gray-resistance. This information helps the technician to modify the chemical formulation to open resistant hair cuticles in order to better accept color or chemical agents.

13. Classifying whether the client's hair has concentrated gray or gray streaking. Typical responses may include no, yes—temples, yes—top, yes—back, or yes sides, for example. Certain hair products absorb differently because natural pigmentation is missing from the gray area. Therefore, knowing this information will help the Technician adjust the hair product formula to achieve greater product absorption and ultimately get better results and product durability.

14. Determining the percentage of gray. Possible ranges of gray may include: 0%, 1-30%, 31-60%, 61-80%, or 80-100%. Certain hair products absorb differently because natural pigmentation is missing from the gray area. Therefore, knowing this information will help the Technician adjust the hair product formula to achieve greater product absorption and ultimately get better results and product durability.

15. Assessing the number of hours per week spent outdoors in the sun. For example, the number of hours may be classified as 0-1 hours, 1-5 hours, 5+hours. The sun is a bleaching agent that will affect the durability of a hair care product. Knowing the level of exposure to the sun allows the technician to adjust the formula for greater resistance to ultraviolet rays, which reduces premature fading and adds to the overall product durability. This information may help identify additional products and or services which may improve the quality and duration of hair treatment products and services

16. Determining whether the client's hair exposed to well water more than once a week. Well water contains minerals that affect the chemical compounds used in hair products. Knowing the type of water that a person is exposed to helps the technician understand the iron, copper sulfide and lime content, for example. This may impact the the quality/durability of custom designed hair care products.

17. Determining whether the client's hair is exposed to pool water more than once a week. Pool water typically has a higher content of chlorine and fluoride which can affect the chemical compounds used in hair products. Knowing the type of water that a person is exposed to helps the Technician understand the exposure risks that can damage hair and affect the quality/durability of custom designed hair care products

18. Determining whether the client's hair is exposed to hard water more than once a week. Hard water typically has a higher content of minerals and lime, which can affect the chemical compounds used in hair products. Knowing the type of water that a person is exposed to helps the Technician understand the exposure risks that can damage hair and affect the quality/durability of custom designed hair care products

19. Determining whether the client's hair has been colored recently. Typical ranges may include coloring within the last two weeks, 2-4 weeks ago, 4-8 weeks ago, or more than 8 weeks ago. This information provides the technician a point of reference to understand what has worked in the past, and what hasn't. Additionally, some of these product residues may remain in the client's hair, which can affect the salon formulation for appropriate hair care products.

20. Determining the type of coloring process. For example, a client may have not used any products, or may have permed, straightened, high-lighted, or bleached hair. This information provides the technician a point of reference to understand what has worked in the past, and what hasn't. Additionally, some of these process residues may still be in the client's hair, which can affect the formulation for appropriate hair care products.

21. Determining whether the client has any previous hair coloring problems. Typical problems may be bad coverage, condition, fading, or brassy appearance, for example. Also, knowledge of the brand and formula information of previous products may be used. This information provides the technician a point of reference to understand what has worked in the past, and what hasn't. Additionally, some of these product residues may remain in the client's hair, which can affect the salon formulation for appropriate hair care products.

22. Determining the closest color of the client's hair roots. By using hair color swatches, for example, the root color may be assessed. This information helps the technician determine the base, or natural color of the hair so that an appropriate formula can be determined to maximize results.

23. Determining previous colored or chemically treated hair. By examining the color of the client's hair ends with the aid of hair color swatches, for example, a determination of the current color of the hair can be made so that an appropriate formula can be determined to maximize results.

24. Indicating the desired hair color. Using hair color swatches, for example, a client may indicate a desired hair color, or a target hair color. This information helps the technician determine the target color of the hair so that an appropriate formula can be determined to maximize results.

Video Streaming

In addition to the hair color swatches, the method of the present invention contemplates use of digital imaging and video streaming technologies to assist in modeling. For example, sample hair and facial colors, textures, and tones may be used to help clients identify existing and target colors and physical characteristics. All information gathered will be used to formulate the product and services to meet a client's exacting needs. Once a client's formula is established, additional products and services can be custom developed, mixed, and mailed directly to the client or picked up at a designated studio or certified location for clients to apply at home, or other remote location.

The present method contemplates using technicians to properly interpret the evaluation/analysis data, formulate the appropriate customized mixture, and accurately prescribe application procedures for guaranteed results.

A technician may be a person certified and licensed by a recognized state board for cosmetology, and may be required to complete six months of comprehensive training on specific products, services, and methodologies. In addition to the licensing and training, a cosmetologist may need to complete at least 24 months of apprentice work with hair products, services and methodologies under the supervision of a technician.

Phase Two: Fulfillment:

After evaluating the hair type of a given client, a technician may then customize the products, in phase II, block 30 of FIG. 1. The customization step utilizes the information gathered during the evaluation step. For example, the following criteria would be used in a possible method of the present invention:

1. A technician or expert machine programmer may interpret the technical data gathered from the evaluation and analysis step. This data includes, as previously discussed, may include the following information:

a. Root color—color of the root follicles of hair.

b. End color—color of ends of hair.

c. Percentage of gray.

d. Previous color treatments.

e. Porosity.

f. Texture.

g. Scalp type/condition.

h. Details about water used on hair.

2. Determining the target color.

3. Building a formula based on the above and the following:

a. Exposure to sun.

b. Strength of oxide catalyst required.

c. Hydrogen peroxide percentage required to achieve the appropriate color.

d. Depth of pigment and skin tone coloration.

4. Application duration and timing is determined by a technician who evaluates all responses to the analysis questions then prescribes a recommended application time for the customized formula to achieve the optimal results.

5. Assessing the length of hair to determine quantity/percentage of customized formula mixture.

Materials.

Once the aforementioned information, analysis, evaluation and selection is complete, specific materials are selected and arranged. One material is the coloring, which is readily commercially available and typically comes in 100 ml tubes. The selection of coloring may include as many as sixty different shades, for example: ten shades of natural; six shades of ash; four reds; four shades of mahogany; six gold shades; four extra gold colors; four high-lift shades (lift is the term used universally for lightening/brightening hair color); one blue-bleach; seven concentrates; three coppers; one shade of violet; one neutral shade; one tobacco shade, one light tobacco; and three beiges, for example.

Next, the color combinations are selected (typically more than one color is used during this process). Varying quantities are selected depending on the analysis and the desired results.

Another material that may be combined is an oxide cataylist, such as hydrogen peroxide, which comes in 1,000 ml containers. There are typically four strengths denoted by volume: 10 volume for depositing color into the hair; 20 volume for 1-2 levels of lift (lightening); 30 volume for 2-3 levels of lift; 40 volume for 3-5 levels of lift, for example.

The customization of hair products combines a mixture of the appropriate levels of hydrogen peroxide with the appropriate coloring to accommodate past and current hair status (as established during analysis) to best meet the target needs for the client. This customization process may be referred to as calibration of a color formula, and is represented by block 35 in FIG. 2.

Once a client's customized formula has been established, this mixture may be recorded and stored in the client's database. These unique formulas can then be used for the customization of other hair products, such as conditioners, shampoos, gels, hair sprays or rinse agents, for example, as would best meet the client's individual grooming needs.

As a client needs or desires to adjust the target color or individual formula to accommodate a change in any of the analysis factors, these adjustments can be recorded for future reference and product formulations.

With calibration complete (block 35), a coloring kit may be assembled, block 5. Accordingly, as represented in block 37 a coloring kit may include gloves, coloring and instructions, for example.

Phase Three: Distribution of Custom Formulas.

Once finalized, the customized mixtures are delivered through traditional mail services or picked up in person from an authorized salon and is represented in FIG. 1 as block 50. Thus, the assembled coloring kit or sample kit may be distributed, as represented by block 51 in the Figs.

The present invention may be embodied as methods and apparatus for practicing those methods. The present invention can also be embodied in the form of computer program code embodied in tangible media, such as floppy disks, CD-ROMs, hard drives, or any other computer-readable storage medium, wherein, when the computer program code is loaded into and executed by a computer, the computer becomes an apparatus for practicing the invention. As is well known in the art, the code for implementing features of the present invention can be implemented over a distributed computing system of clients and servers.

The program code encoded in tangible media creates the means for causing the computer to perform the various operations of the present invention. The present invention can also be embodied in the form of computer program code, whether stored in a storage medium loaded into and/or executed by a computer, or transmitted over a transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose computer, the computer program code combines with the computer to provide a unique device that operates analogously to specifically designed circuits.

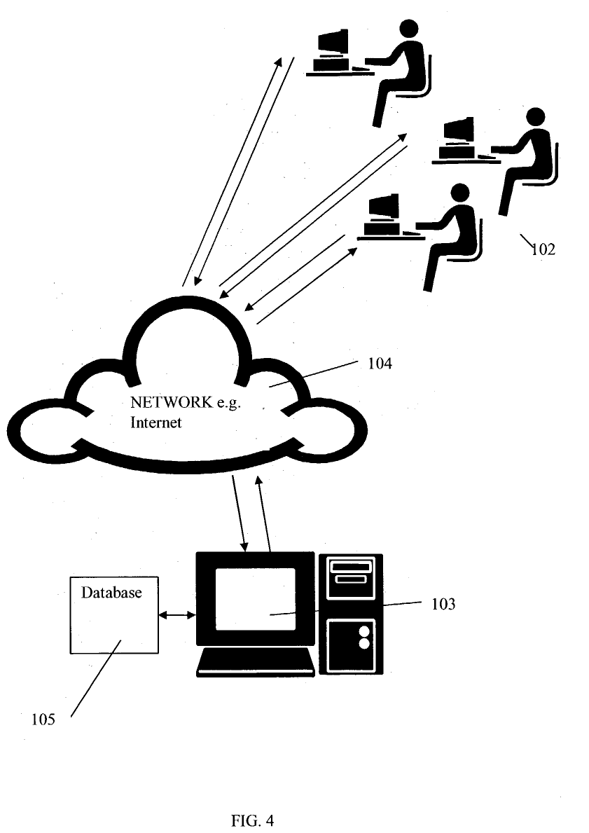

For example, as illustrated in FIG. 4, remote computers 102 may interact with the database 105. The remote computers 102 may be located in homes, at salons, or at other locations, for example. Using a network 104, such as the Internet, the computers 102 may access the database 105. Accordingly, individual profiles and custom formulations may be generated. Additionally, the database 105 may have an associated computer 103 so that the profile may be generated directly from the database 105.

Persons skilled in the art will recognize that many modifications and variations are possible in the details, materials, and arrangements of the parts and actions which have been described and illustrated in order to explain the nature of this invention and that such modifications and variations do not depart from the spirit and scope of the teachings and claims contained therein.

What is claimed:

1. A method for providing hair or skin products for a client comprising the following steps:
evaluating the hair by acquiring a set of hair color attributes comprising a hair color profile;
customizing the products according to the hair color profile; and
distributing the products to a client matching the hair color profile.

2. The method of claim 1 wherein evaluating the hair includes two or more of the following steps:
receiving hair color attributes from the client intending to use a product;
interpreting the personal information;
selecting a set of hair color swatches;
presenting the set of hair color swatches to the client;
receiving a hair color swatch selection from the client; and
formulating the client hair color according to the swatch and personal information.

3. The method of claim 2 wherein receiving hair color attributes is performed over a computer network.

4. The method of claim 2 wherein evaluating the hair further comprises the steps of:
using digital imaging or video streaming to model the hair.

5. The method of claim 1 wherein the step of customizing the products further comprises the steps of:
developing or selecting a client-specific formula;
formulating a client-specific mixture; and
prescribing an application duration and timing for the client.

6. A method for providing hair products for a client comprising the following steps:
receiving a hair color profile from the client over a computer network;
interpreting the personal information;
selecting hair color swatches for the client;
presenting hair color swatches to the client; and
receiving a hair color selection from the client.

7. The method of claim 6 wherein the method further includes two or more of the following steps:
modeling the client hair color selection according to the swatch and personal information;
developing a client-specific formula;
formulating a client-specific mixture;
prescribing an application duration and timing for the client; and
distributing the mixture to the client.

8. The method of claim 6 further comprising the steps of:
using digital imaging or video streaming to model the hair.

9. The method of claim 6 wherein the step of receiving personal information from the client further comprises the steps of:
receiving client personal information from a mail-in form.

10. The method of claim 6 wherein the step of receiving personal information from the client further comprises the steps of:
receiving client personal information from an on-line form.

11. The method of claim 6 wherein the step of receiving personal information from the client further comprises the steps of:
receiving client personal information from a facsimile machine.

12. The method of claim 6 wherein the step of receiving personal information from the client further comprises the steps of:
receiving client personal information from a telephone sales conference.

13. The method of claim 6 wherein the step of receiving personal information from the client further comprises the steps of:
receiving client personal information from a technician.

14. A method for providing hair products by evaluating a client's hair by obtaining a hair color profile based on three or more of the following attributes:
the client's eye color,
the client's hair's work history,
the ethnicity of the client,
the client's skin tone,
the client's skin undertones,
the client's hair texture,
the client's hair density,
the general condition of the client's scalp,
the client's hair coloring allergies,
the length of hair,
the client's hair porosity,
the amount of gray-resistance,
the nature of gray hair,
the percentage of gray,
the number of hours per week spent outdoors,
whether the hair is exposed to well water,
whether the hair is exposed to pool water,
whether the hair is exposed to hard water,
whether the hair was recently colored,
the type of coloring process,
whether the client has any previous hair coloring problems,
whether the client has any current hair coloring problems,
the color of the hair roots,
previous colored or chemically treated hair,
a desired hair color;

15. The method of claim 13 wherein the method further includes at least one of the following steps:
fulfilling a custom hair product order comprising the following steps
interpreting information provided in the evaluating step,
modeling the client's hair
customizing a formulation,
selecting material for the mixture according to the formulation,
formulating a mixture,
recommending an application time for the mixture, and
distributing the mixture to the client.
